(19) United States
(12) Patent Application Publication
(10) Pub. No.: US 2026/0253758 A1
(43) Pub. Date: Aug. 27, 2026

(54) RADIONUCLIDE PRODUCTION SYSTEM AND RADIONUCLIDE PRODUCTION METHOD

(71) Applicant: HITACHI HIGH-TECH CORPORATION, Tokyo (JP)

(72) Inventors: Takahiro TADOKORO, Tokyo (JP); Mizuho MAEDA, Tokyo (JP); Kento NISHIDA, Tokyo (JP); Yuichiro UENO, Tokyo (JP); Yuko KANI, Tokyo (JP); Takahiro SASAKI, Tokyo (JP); Takahiro WATANABE, Tokyo (JP)

(21) Appl. No.: 18/855,148

(22) PCT Filed: Jan. 27, 2023
(86) PCT No.: PCT/JP2023/002739

§ 371 Date: Oct. 8, 2024

(30) Foreign Application Priority Data
Jun. 16, 2022 (JP) 2022-097086

(51) Int. Cl. G21G 1/12; G21G 1/00; G21G 1/10; G21G 4/08; H05H 7/04

(52) U.S. Cl. CPC G21G 1/12; G21G 1/001; G21G 4/08; H05H 7/04; G21G 2001/0089; G21G 1/10; H05H 2007/046; H05H 2277/116

(57) ABSTRACT

Provided are a radionuclide production system and a radionuclide production method which make it possible to produce radionuclides with a compact, lightweight device with high safety and good efficiency. A radionuclide production system according to the present invention comprises: an electron beam accelerator that emits an electron beam; a bremsstrahlung radiation generation target that generates bremsstrahlung radiation with the emitted electron beam; and a radionuclide production target that includes a raw material which produces a radionuclide upon irradiation with the generated bremsstrahlung radiation. The thickness of the bremsstrahlung radiation generation target is set in the range in which the production rate of the radionuclide reaches a peak and with the condition that the amount of electron beam irradiation on the radionuclide production target is smallest within said range.

### TECHNICAL FIELD

The present invention relates to a radionuclide production system and a radionuclide production method.

### BACKGROUND ART

In the related art, actinium-225 (Ac-225, ²²⁵Ac), which is an alpha ray-emitting nuclide used for research and development as a raw material nuclide for a therapeutic agent, is produced by decay of thorium-229(Th-229, ²²⁹Th) that is a parent nuclide. Currently, there are only three facilities that can supply clinically available radionuclide Ac-225 in the world, that is, the Institute for Transuranium Elements (ITU) in Karlsruhe, Germany, the Oak Ridge National Laboratory (ORNL) in the United States, and the Institute of Physics and Power Engineering (IPPE) in Obninsk, Russia.

Th-229 is not found in nature and is produced by decay of uranium-233(U-233, ²²³U), but U-233 will not be produced in the future due to nuclear protection. Therefore, a producible amount of Ac-225 in the world is only an amount produced by the decay of Th-229 that is produced by the decay of U-233 currently held in the world. The amount is sufficient for use in preclinical testing or the like, but a large shortage in the future is predicted, and production using an accelerator is desired.

Regarding production of Ac-225 using the accelerator, a test for the production using a cyclotron, which utilizes a Ra-226 (p, 2n) Ac-225 reaction using naturally occurring radium 226 (Ra-226, ²²⁶Ra), is being conducted at ORNL, BNL, and the National Institutes for Quantum Science and Technology in Japan, but the production has not been commercialized. The production using the cyclotron has a problem that since a range of an accelerated proton in Ra-226 that is a target is short, mass production is not possible even when Ra-226 that is the target is thickened. The production using the cyclotron further has a problem that since most of energy of the accelerated proton is lost in the target, it is difficult to remove heat from the target, and therefore, a current value and the energy cannot be increased for the mass production.

As another method for production for Ac-225, for example, PTL 1 describes a method for producing Ac-225 by irradiating a bremsstrahlung radiation generation target with an electron accelerated by an electron beam accelerator to generate a bremsstrahlung radiation and irradiating Ra-226 used as a raw material with the bremsstrahlung radiation. In addition, for example, PTL 2 describes a method for producing a radionuclide for medical use by irradiating a converter (bremsstrahlung radiation generation target) with an electron accelerated by an electron beam accelerator to generate a bremsstrahlung radiation and irradiating a plurality of plate-shaped target material plates with the bremsstrahlung radiation. In this method, a diameter or an average thickness of a target material plate in a front plate group provided on a front side is set smaller than a diameter or an average thickness of a target material plate in a rear plate group provided on a rear side.

### CITATION LIST

### Patent Literature

PTL 1: JP2020-183926A

PTL 2: JP 6752590B

### SUMMARY OF INVENTION

### Technical Problem

However, techniques described in PTL 1 and PTL 2 have a problem that a thermal load becomes higher by irradiating, with the electron beam accelerated by the electron beam accelerator, a radionuclide production target that is a solution or solid containing a raw material for producing a radionuclide and a container that contains the radionuclide production target, and the like. Accordingly, there are concerns that the radionuclide production target and the container may be damaged or brittle.

The invention has been made in view of the above situation. An object of the invention is to provide a radionuclide production system and a radionuclide production method, which can produce a radionuclide with high safety and good efficiency by using a small and lightweight device.

### Solution to Problem

A radionuclide production system according to the invention, which solves the above problems, includes: an electron beam accelerator configured to emit an electron beam; a bremsstrahlung radiation generation target configured to generate a bremsstrahlung radiation by the emitted electron beam; and a radionuclide production target containing a raw material for producing a radionuclide by being irradiated with the generated bremsstrahlung radiation. A thickness of the bremsstrahlung radiation generation target is set within a range in which a production rate of the radionuclide reaches a peak, and under a condition in which an irradiation amount of the electron beam for the radionuclide production target is minimized within the range.

### Advantageous Effects of Invention

The radionuclide production system and the radionuclide production method according to the invention can produce a radionuclide with high safety and good efficiency by using a small and lightweight device.

Problems, configurations, and effects other than those described above become apparent from the following description of embodiments.

### BRIEF DESCRIPTION OF DRAWINGS

FIG. 1 is a schematic diagram illustrating a configuration example of a radionuclide production system according to an embodiment of the invention.

FIG. 2 is a diagram illustrating an example of a relation between a thickness of a bremsstrahlung radiation generation target and a production rate of a radionuclide (upper graph), and a relation between the thickness of the bremsstrahlung radiation generation target and an amount of an electron beam passing through the bremsstrahlung radiation generation target (lower graph).

FIG. 3 is a diagram illustrating an example of the bremsstrahlung radiation generation target.

FIG. 4 is a schematic diagram illustrating another configuration example of the radionuclide production system according to the embodiment of the invention.

FIG. 5 is a schematic diagram illustrating an example of an electron beam removal device.

FIG. 6 is a diagram illustrating an example of an operation of the electron beam removal device.

FIG. 7 is a diagram illustrating another example of the operation of the electron beam removal device.

FIG. 8 is a flowchart illustrating a content of a radionuclide production method according to an embodiment of the invention.

### DESCRIPTION OF EMBODIMENTS

Hereinafter, a radionuclide production system and a radionuclide production method according to an embodiment of the invention are described in detail with reference to the drawings as appropriate. In the description of the embodiments, substantially the same or similar components are denoted by the same reference numerals, and a description thereof may be omitted in a case where the description thereof is redundant.

### (Radionuclide Production System S)

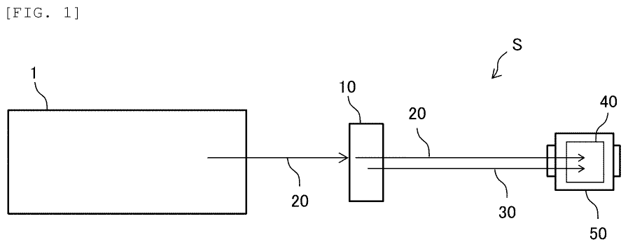

FIG. 1 is a schematic diagram illustrating a configuration example of a radionuclide production system S according to the present embodiment. As illustrated in FIG. 1, the radionuclide production system S includes an electron beam accelerator 1, a bremsstrahlung radiation generation target 10, and a radionuclide production target 40.

The electron beam accelerator 1 emits an electron beam 20. Specifically, the electron beam accelerator 1 accelerates the electron beam 20 and emits the accelerated electron beam 20 toward the bremsstrahlung radiation generation target 10.

The bremsstrahlung radiation generation target 10 generates a bremsstrahlung radiation 30 by the emitted electron beam 20.

The radionuclide production target 40 contains a raw material for producing a radionuclide by being irradiated with the generated bremsstrahlung radiation 30. The raw material may be contained in a solution or solid. When the raw material is contained in the solid, the entire solid may be made of the raw material, or a part of the solid may contain an element or a compound other than the raw material, such as an unavoidable impurity. Examples of the solution that can contain the raw material include a water solution and an acid solution. It is preferable that the radionuclide production target 40 is, for example, a cube having a side length of several centimeters (it is preferable that a solution containing the raw material is contained in a cube-shaped container having an inner side length of several centimeters when the solution is used), but is not limited to this.

In the radionuclide production system S according to the present embodiment, a thickness of the bremsstrahlung radiation generation target 10 is set within a range in which a production rate (production amount) of the radionuclide reaches a peak, and under a condition in which an irradiation amount of the electron beam 20 for the radionuclide production target 40 is minimized within the range.

The production rate of the radionuclide can be understood based on an amount of radionuclide produced per unit time (Bq/s).

The irradiation amount of the electron beam 20 can be understood based on an amount per unit time of the electron beam 20 with which the radionuclide production target 40 is irradiated. The amount of the electron beam 20 can be understood based on, for example, at least one selected from an irradiation dose (C/kg), an absorbed dose (Gy), a dose equivalent (Sv), energy (eV), and the like.

In this way, the radionuclide production system S generates the bremsstrahlung radiation 30 by irradiating the bremsstrahlung radiation generation target 10 with the electron beam 20 accelerated by the electron beam accelerator 1. By irradiating the radionuclide production target 40, which is a solution or solid containing the raw material of the radionuclide, with the generated bremsstrahlung radiation 30, a nuclear reaction occurs between the bremsstrahlung radiation 30 and the raw material to produce a radiation nuclide to be used as a raw material of a medical drug. For example, the radionuclide is produced by a (γ, n) reaction in which one neutron is generated by irradiating a nuclide used as the raw material with one bremsstrahlung radiation 30. When Ac-225 is produced as a produced nuclide, Ra-226 is used as the nuclide used as the raw material. Ra-225 is produced by the (γ, n) reaction reaction between Ra-226 and the bremsstrahlung radiation 30. The produced Ra-225 becomes Ac-225, which is a progeny nuclide, at a half-life of 14.8 days. A typical alpha ray-emitting nuclide used as a raw material of a therapeutic drug is Ac-225. Ac-225 becomes francium-221 (Fr-221), which is a progeny nuclide, at a half-life of 10.0 days. Fr-221 becomes astatine-217(At-217 ) at a half-life of 4.9 minutes, and At-217 becomes bismuth-213(Bi-213 ) at a half-life of 32 milliseconds. Ac-225 and the progeny nuclide thereof are effective for therapy, but Ra-226 and Ra-225 are unnecessary nuclides for therapy because Ra-226 and Ra-225 do not emit an alpha ray, and are required to be separated and purified from Ac-225. Since Ra-226, which is the raw material for producing the radionuclide, is valuable, it is desirable to recover and reuse Ra-226. Ra-226 decays into radon-222 (Rn-222) that is a rare gas (boiling point is −61.7° C). Since Rn-222 is a gaseous radionuclide that emits an alpha ray, when Rn-222 is diffused into the environment, a progeny nuclide of the diffused Rn-222 adheres to everywhere in the environment, causing a large influence on the environment. Therefore, it is desirable not to release Rn-222 into the environment during the production, separation and purification of the radionuclide. Rn-222 is a rare gas, and is thus difficult to be collected chemically. Therefore, examples of a method for collecting Rn-222 include physical adsorption using cooled activated carbon.

The electron beam accelerator 1 can be made smaller in size and lighter as compared with a proton accelerator or a heavy particle accelerator under the same acceleration energy. A reaction cross section area in the (γ, n) reaction in which Ra-225 is produced from Ra-226 by using the electron beam accelerator 1 (Ra-226 (γ, n) Ra-225) is substantially the same as a reaction cross section area in a method (Ra-226 (p, 2n) Ac-225) for directly producing Ac-225 by a reaction in which two neutrons are emitted by irradiating Ra-226 with a proton accelerated by a proton accelerator, and therefore, a radionuclide production portion can be made smaller in size. A reaction cross section area in a method (Ra-226 (n, 2n) Ra-225) using a reaction, in which Ra-226 is irradiated with a high-speed neutron by using a heavy particle accelerator to emit two high-speed neutrons including the emitted high-speed neutron, is slightly larger by an order of magnitude. However, in this case, in order to generate a large amount of high-speed neutrons, it is necessary to irradiate, with a deuteron accelerated by a cyclotron, a carbon target, or a target such as a metal in which tritium is absorbed. In this case, since it is necessary to shield the large amount of high-speed neutrons to be generated, the device is made larger in size. Further, the entire structural object of the device is highly radioactive by the large amount of high-speed neutrons. With respect to this, in the radionuclide production system S, the electron beam accelerator 1 is used, and therefore, these problems in the proton accelerator and the heavy particle accelerator can be solved.

A part of the electron beam 20 accelerated by the electron beam accelerator 1 passes through the bremsstrahlung radiation generation target 10, and is incident on the radionuclide production target 40 and a container 50 that contains the radionuclide production target 40. The electron beam 20 that has passed through the bremsstrahlung radiation generation target 10 hardly contributes to the production of the radionuclide to be used as the raw material of the medical drug, but causes a thermal load or damage to the radionuclide production target 40, the container 50, and the like, thereby lowering safety of the radionuclide production system S. Therefore, in the radionuclide production system S, the amount of the electron beam 20, which passes through the bremsstrahlung radiation generation target 10 and is incident on the radionuclide production target 40 and the container 50, is required to be reduced.

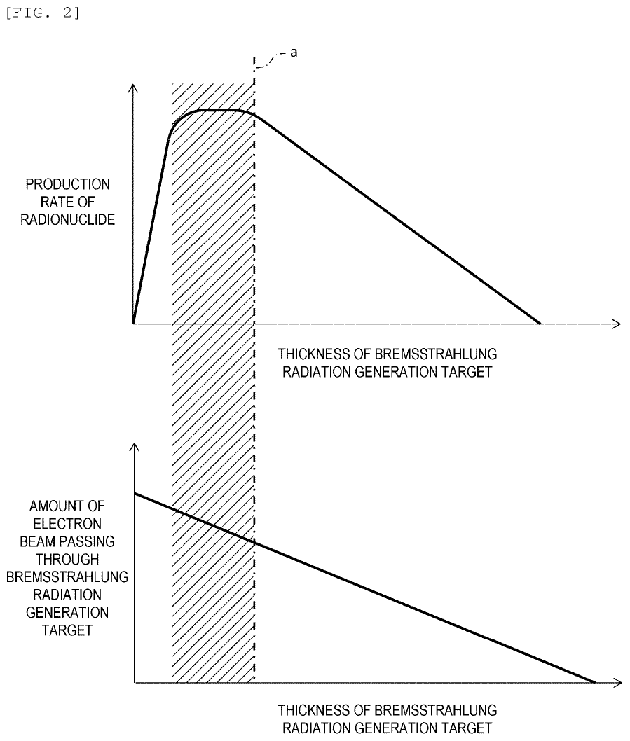

Here, FIG. 2 illustrates an example of a relation between the thickness of the bremsstrahlung radiation generation target 10 and the production rate of the radionuclide (upper graph), and a relation between the thickness of the bremsstrahlung radiation generation target 10 and the amount of the electron beam 20 passing through the bremsstrahlung radiation generation target 10 (lower graph).

As illustrated in the upper graph in FIG. 2, as the thickness of the bremsstrahlung radiation generation target 10 increases, a generation amount of the bremsstrahlung radiation 30 first increases, and therefore, the production rate of the radionuclide increases. However, when the thickness of the bremsstrahlung radiation generation target 10 increases, an effect of shielding the bremsstrahlung radiation 30 also improves (the effect of shielding the bremsstrahlung radiation 30 is also generated when w the thickness of the bremsstrahlung radiation generation target 10 is small). Therefore, when the thickness of the bremsstrahlung radiation generation target 10 reaches a certain thickness, the generation (production rate) of the bremsstrahlung radiation 30 and the effect of shielding the bremsstrahlung radiation 30 are balanced, and the production rate of the radionuclide no longer increases. Thereafter, when the thickness of the bremsstrahlung radiation generation target 10 further increases, the effect of shielding the bremsstrahlung radiation 30 becomes superior, and the irradiation amount of the bremsstrahlung radiation 30 decreases, thereby decreasing the production rate of the radionuclide. In addition, when the bremsstrahlung radiation generation target 10 is irradiated with the electron beam 20, heat is generated and deterioration due to the irradiation occurs in the bremsstrahlung radiation generation target 10. Accordingly, soundness of the bremsstrahlung radiation generation target 10 is deteriorated. From a viewpoint of maintaining the soundness of the bremsstrahlung radiation generation target 10, it can be said that it is preferable to make the thickness of the bremsstrahlung radiation generation target 10 as large as possible. However, when the thickness is too large, the production rate of the radionuclide decreases as described above. Therefore, it is preferable that the thickness of the bremsstrahlung radiation generation target 10 is set such that the production rate of the radionuclide does not decrease and the deterioration of the soundness of the bremsstrahlung radiation generation target 10 can be reduced as much as possible.

As illustrated in the lower graph in FIG. 2, as the thickness of the bremsstrahlung radiation generation target 10 increases, the amount of the electron beam 20 passing through the bremsstrahlung radiation generation target 10 decreases, and the irradiation amount of the electron beam 20 for the radionuclide production target 40 and the container 50 decreases. Therefore, the radionuclide production system S can reduce the thermal load or the damage to the radionuclide production target 40, the container 50, and the like as the thickness of the bremsstrahlung radiation generation target 10 increases.

Therefore, as illustrated in both graphs in FIG. 2, the thickness of the bremsstrahlung radiation generation target 10 is set, as described above, within the range in which the production rate of the radionuclide reaches a peak, and under a condition in which the irradiation amount of the electron beam 20 for the radionuclide production target 40 is minimized within the range (this condition is also a condition under which the deterioration of the soundness of the bremsstrahlung radiation generation target 10 can be reduced as much as possible). Accordingly, the radionuclide production system S can reduce the thermal load or the damage to the bremsstrahlung radiation generation target 10, the radionuclide production target 40, the container 50, and the like (with high safety), and efficiently produce the radionuclide.

The thickness Of the bremsstrahlung radiation generation target 10 within the range as described above varies depending on the energy of the electron beam 20. Therefore, it is preferable that the thickness of the bremsstrahlung radiation generation target 10 is set to an optimal value according to the energy of the electron beam 20. Referring to the upper graph in FIG. 2, for example, when the electron beam 20 of 35 MeV is used and tungsten is used as the bremsstrahlung radiation generation target 10, the production rate of the radionuclide increases until the thickness of tungsten is 2 mm, the production amount of the radionuclide is substantially constant in the thickness from 2 mm to 6 mm, and the production rate of the radionuclide decreases when the thickness exceeds 6 mm. Referring to the lower graph in FIG. 2, the amount of the electron beam 20 passing through tungsten decreases as the thickness of tungsten increases. For this reason, when the electron beam 20 of 35 MeV is used, by setting the thickness of tungsten, which is the bremsstrahlung radiation generation target 10, to 6 mm (that is, by setting the thickness of tungsten within a range indicated by oblique lines in FIG. 2, and more preferably under a condition of an alternate long and a dash-dotted line a), the thermal load or the damage to the bremsstrahlung radiation generation target 10, the radionuclide production target 40, the container 50, and the like can be reduced without decreasing the production rate of the radionuclide.

Accordingly, in the radionuclide production system S, for example, when the energy of the electron beam 20 is increased to use the electron beam 20 of 40 MeV and tungsten is used as the bremsstrahlung radiation generation target 10, the bremsstrahlung radiation generation target 10 can have any thickness exceeding 6 mm. In addition, in the radionuclide production system S, for example, when the energy of the electron beam 20 is reduced to use the electron beam 20 of 30 MeV and tungsten is used as the bremsstrahlung radiation generation target 10, the bremsstrahlung radiation generation target 10 can have any thickness less than 6 mm. That is, the thickness of the bremsstrahlung radiation generation target 10 can be made large when the energy of the electron beam 20 is high and can be made small when the energy is low.

In addition to tungsten, the bremsstrahlung radiation generation target 10 can also be made of a material which is not a ferromagnetic material, such as platinum or tantalum. In this case, the bremsstrahlung radiation generation target 10 can have any thickness according to the material. It is preferable that the thickness of the bremsstrahlung radiation generation target 10 depending on the material is set in advance by conducting a test or a simulation.

In this way, in the radionuclide production system S, the thickness of the bremsstrahlung radiation generation target 10 can be changed depending on the energy the electron beam 20 and the material. Therefore, the radionuclide production system S can appropriately obtain an effect of reducing the thermal load or the damage to the bremsstrahlung radiation generation target 10, the radionuclide production target 40, the container 50, and the like without reducing the production rate of the radionuclide.

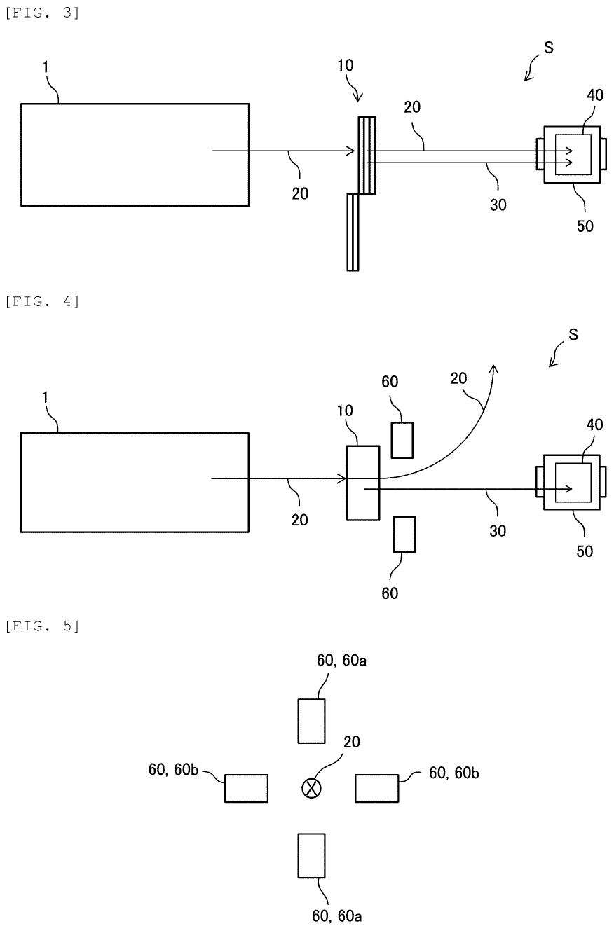

Here, FIG. 3 is a diagram illustrating an example of the bremsstrahlung radiation generation target 10. As illustrated in FIG. 3, the bremsstrahlung radiation generation target 10 may include, for example, a plurality of (for example, ten (five in FIG. 3) ) plate-shaped targets each having a thickness of 1 mm, and the plate-shaped bremsstrahlung radiation generation target 10 may be inserted or removed according to the energy of the electron beams 20 to adjust the thickness to an appropriate thickness. In this way, when output setting of the energy of the electron beam 20 is changed, the thickness of the bremsstrahlung radiation generation target 10 can be adjusted according to the energy of the electron beam 20. The plurality of plate-shaped bremsstrahlung radiation generation targets 10 may be provided in a form of being in close contact with each other or at a predetermined interval (for example, every other bremsstrahlung radiation generation targets 10) after insertion and removal. When the plurality of plate-shaped bremsstrahlung radiation generation targets 10 are provided at a predetermined interval, cooling performance can be improved. The thickness of the plate-shaped bremsstrahlung radiation generation target 10 may be, for example, 2 mm or 3 mm. The thicknesses of the plurality of plate-shaped bremsstrahlung radiation generation targets 10 may be different from each other. Regardless of which of these forms is adopted, in the radionuclide production system S, the thickness of the bremsstrahlung radiation generation target 10 can be flexibly adjusted according to the energy of the electron beam 20.

FIG. 4 is a schematic diagram illustrating another configuration example of the radionuclide production system S according to the present embodiment. As illustrated in FIG. 4, in the radionuclide production system S, an electron beam removal device 60 can be provided between the bremsstrahlung radiation generation target 10 and the radionuclide production target 40. The electron beam removal device 60 changes a traveling direction of the electron beam 20 that has passed through the bremsstrahlung radiation generation target 10, and separates and removes the electron beam 20 from the bremsstrahlung radiation 30. Therefore, by providing the electron beam removal device 60, the radionuclide production system S can further reduce the thermal load or the damage to the radionuclide production target 40, the container 50, and the like, and can produce the radionuclide with high safety and good efficiency by using a small and lightweight device.

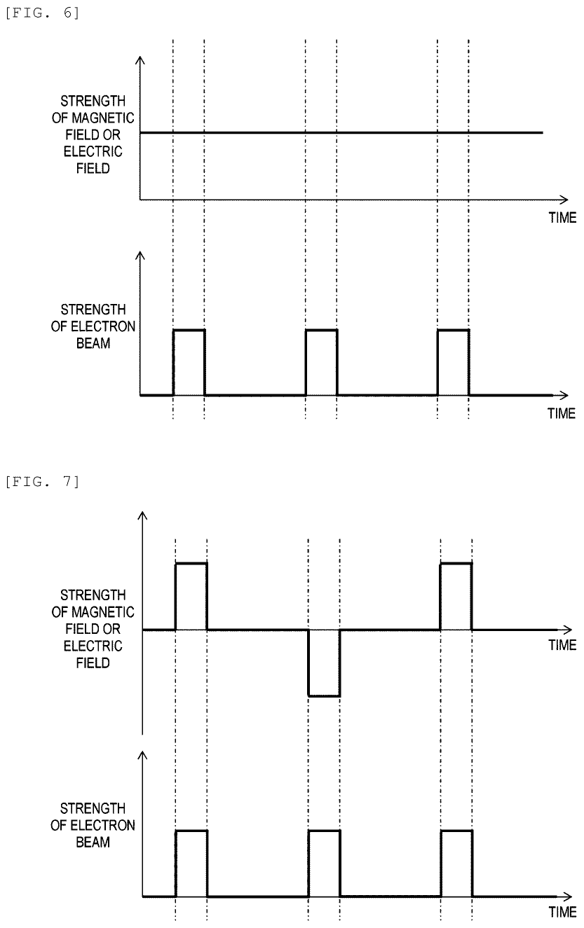

At least one of a magnetic field generator 60a (see FIG. 5) and an electric field generator 60b (see FIG. 5) using one or more sets of permanent magnets or electromagnetic coils can be used in the electron beam removal device 60. The bremsstrahlung radiation 30 is not influenced by an electric field or a magnetic field, but the traveling direction of the electron beam 20 is changed when the electric field or the magnetic field is present. Therefore, when the electron beam removal device 60 including the magnetic field generator 60a or the electric field generator 60b is provided between the bremsstrahlung radiation generation target 10 and the radionuclide production target 40, the traveling direction of the electron beam 20 that has passed through the bremsstrahlung radiation generation target 10 is changed by the electric field or the magnetic field generated by the electron beam removal device 60, and the radionuclide production target 40, the container 50, and the like are not irradiated, or the irradiation can be reduced. Therefore, the radionuclide production system S can reduce the thermal load or the damage to the radionuclide production target 40 and the container 50.

When the magnetic field generator 60a or the electric field generator 60b as described above are used as the electron beam removal device 60, it is desirable to use the material that is not a ferromagnetic material in the bremsstrahlung radiation generation target 10 and the container 50. In this way, when the magnetic field is used, an influence of a stress acting on the bremsstrahlung radiation generation target 10, the container 50, and the like by the magnetic field can be prevented. The ferromagnetic material refers to, among magnetic materials, a magnetic material in which magnetic moments of adjacent magnetic atoms in a crystal are arranged in parallel and that exhibits strong magnetism to the outside, and examples of the ferromagnetic material include iron, cobalt, nickel, or an alloy containing any one of these as a main component. Therefore, the material that is not a ferromagnetic material refers to a material other than these ferromagnetic materials. For example, the bremsstrahlung radiation generation target 10 can be made of tungsten, platinum, tantalum, or the like as described above. For example, the container 50 can be made of aluminum, a ceramic material, or the like.

Regarding the electron beam 20 whose traveling direction is changed by the electron beam removal device 60, it is desirable to adopt a structure in which no structural object is present at least until the electron beam 20 disappears. In this way, since no structural object is present, the thermal load or the damage caused by the electron beam 20 no longer functions. In the structure in which no structural object is present, for example, it is preferable to ensure a space having a radius of about several tens of centimeters to 1 meter at least in a vertical direction with the bremsstrahlung radiation 30 passing between the electron beam removal device 60 and the radionuclide production target 40 as a central axis, and not to provide the structural object. By ensuring such a space, the electron beam 20 whose traveling direction is changed by the electron beam removal device 60 is sufficiently reduced or disappears, and therefore, even when there is a structural object ahead of the electron beam 20, the structural object is not subjected to the thermal load or the damage.

FIG. 5 is a schematic diagram illustrating an example of the electron beam removal device 60. FIG. 5 illustrates a state in which the electron beam 20 passes from a front side to a back side of a paper surface in FIG. 5. As illustrated in FIG. 5, the electron beam removal device 60 is provided with the magnetic field generator 60a including a permanent magnet or an electromagnetic coil such that the magnetic field is generated perpendicularly to a passing direction of the electron beam 20. In this form, a direction of the electric field generated by the electric field generator 60b is set such that the traveling direction of the electron beam 20 is changed to a direction same as the traveling direction of the electron beam 20 changed by the magnetic field generator 60a. For example, the electric field generators 60b may be provided at positions rotated by 90° about the electron beam 20 with respect to a pair of magnetic field generators 60a provided with the electron beam 20 interposed therebetween. In this way, the traveling direction of the electron beam 20 can be changed more strongly by a synergistic effect of the magnetic field and the electric field.

FIG. 6 is a diagram illustrating an example of an operation of the electron beam removal device 60. In the radionuclide production system S, as illustrated in a lower diagram in FIG. 6, the electron beam 20 from the electron beam accelerator 1 may be pulsed. In contrast, as illustrated in an upper diagram in FIG. 6, a strength (strength of the magnetic field or the electric field) of the magnetic field generator 60a and/or the electric field generator 60b of the electron beam removal device 60 can be made constant. In this way, since no special control device is required, the traveling direction of the electron beam 20 can be changed with a simple configuration and at a low cost.

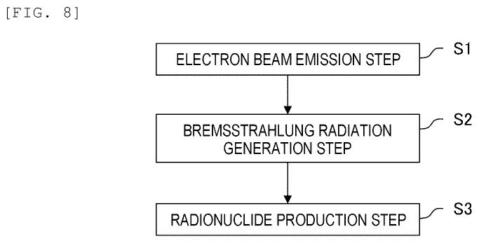

FIG. 7 is a diagram illustrating another example of the operation of the electron beam removal device 60. In the radionuclide production system S, as illustrated in a lower diagram in FIG. 7, the electron beam 20 from the electron beam accelerator 1 may be pulsed. In contrast, as illustrated in an upper diagram in FIG. 7, a polarity (strength of the magnetic field or the electric field) of the magnetic field generator 60a and/or the electric field generator 60b of the electron beam removal device 60 can be changed for each pulse described above. In this way, the traveling direction of the electron beam 20 passing through the bremsstrahlung radiation generation target 10 is changed for each pulse. The traveling direction of the electron beam 20 is changed for each pulse, and therefore, even when there is a structural object in the changed traveling direction, a strength of the electron beam 20 with which the structural object is irradiated can be reduced by half. Therefore, the radionuclide production system S can reduce the thermal load or the damage to the structural object. This is a preferred form when the electron beam removal device 60 includes an electromagnetic coil. That is, the traveling direction of the electron beam 20 passing through the bremsstrahlung radiation generation target 10 can be changed for each pulse by changing the polarity of the electromagnetic coil every predetermined time (for each pulse) according to the pulsed electron beam 20 emitted from the electron beam accelerator 1.

### (Radionuclide Production Method)

FIG. 8 is a flowchart illustrating a content of a radionuclide production method according to the present embodiment. In the radionuclide production method according to the present embodiment, the above radionuclide production system S is used to produce the radionuclide. Therefore, detailed description of each element described for the radionuclide production system S is omitted.

As illustrated in FIG. 8, the radionuclide production method includes an electron beam emission step S1, a bremsstrahlung radiation generation step S2, and a radionuclide production step S3.

In the electron beam emission step S1, the electron beam accelerator 1 emits the electron beam 20. Specifically, the electron beam accelerator 1 accelerates the electron beam 20 and emits the accelerated electron beam 20 toward the bremsstrahlung radiation generation target 10.

In the bremsstrahlung radiation generation step S2, the bremsstrahlung radiation generation target 10 is irradiated with the electron beam 20 to generate the bremsstrahlung radiation 30.

In the radionuclide production step S3, the radionuclide production target 40 containing the raw material for producing the radionuclide by being irradiated with the generated bremsstrahlung radiation 30 is irradiated with the bremsstrahlung radiation 30 to produce the radionuclide.

In the radionuclide production method according to the present embodiment, as described for the radionuclide production system S, the thickness of the bremsstrahlung radiation generation target 10 is set within the range in which the production rate of the radionuclide reaches a peak, and under the condition in which the irradiation amount of the electron beam 20 for the radionuclide production target 40 is minimized within the range. Accordingly, in the radionuclide production method, as described for the radionuclide production system S, the thermal load or the damage to the bremsstrahlung radiation generation target 10, the radionuclide production target 40, the container 50, and the like can be reduced (with high safety), and the radionuclide can be produced efficiently. In the radionuclide production method, the electron beam accelerator 1 is used and can be made smaller in size and lighter as compared with a proton accelerator or a heavy particle accelerator.

The radionuclide production system S and the radionuclide production method according to the invention are described in detail above in the embodiments, but the invention is not limited to the above embodiments, and includes various modifications. For example, the above embodiments are described in detail to facilitate understanding of the invention, and the invention is not necessarily limited to those including all the configurations described above. A part of a configuration of a certain embodiment can be replaced with a configuration of another embodiment, and a configuration of another embodiment can be added to a configuration of a certain embodiment. A part of a configuration according to each embodiment may be deleted, added with, or replaced with another configuration.

### REFERENCE SIGNS LIST

S radionuclide production system
1 electron beam accelerator
10 bremsstrahlung radiation generation target
20 electron beam
30 bremsstrahlung radiation
40 radionuclide production target
50 container
60 electron beam removal device
60a magnetic field generator
60b electric field generator
S1 electron beam emission step
S2 bremsstrahlung radiation generation step
S3 radionuclide production step

1. A radionuclide production system comprising:
an electron beam accelerator configured to emit an electron beam;
a bremsstrahlung radiation generation target configured to generate a bremsstrahlung radiation by the emitted electron beam; and
a radionuclide production target containing a raw material for producing a radionuclide by being irradiated with the generated bremsstrahlung radiation, wherein
a thickness of the bremsstrahlung radiation generation target is set within a range in which a production rate of the radionuclide reaches a peak, and under a condition in which an irradiation amount of the electron beam for the radionuclide production target is minimized within the range.

2. The radionuclide production system according to claim 1, wherein
the thickness of the bremsstrahlung radiation generation target is changed according to energy of the electron beam.

3. The radionuclide production system according to claim 1, further comprising:
an electron beam removal device between the bremsstrahlung radiation generation target and the radionuclide production target, and configured to change a traveling direction of an electron beam passing through the bremsstrahlung radiation generation target and to separate and remove the electron beam from the bremsstrahlung radiation.

4. The radionuclide production system according to claim 3, wherein
the electron beam removal device uses at least one of a magnetic field generator and an electric field generator using one or more sets H permanent magnets or electromagnetic coils.

5. The radionuclide production system according to claim 3, wherein
no structural object is present in the traveling direction of the electron beam changed by the electron beam removal device, at least until the electron beam disappears.

6. The radionuclide production system according to claim 1, wherein
a container configured to contain the radionuclide production target and the bremsstrahlung radiation generation target are made of a material that is not a ferromagnetic material.

7. The radionuclide production system according to claim 4, wherein
the electron beam removal device uses the electromagnetic coils, and a polarity of the electromagnetic coils is changed every predetermined time.

8. A radionuclide production method comprising:
an electron beam emission step of emitting an electron beam from an electron beam accelerator;
a bremsstrahlung radiation generation step of irradiating a bremsstrahlung radiation generation target with the electron beam to generate a bremsstrahlung radiation; and
a radionuclide production step of irradiating, with the bremsstrahlung radiation, a radionuclide production target containing a raw material for producing a radionuclide by being irradiated with the generated bremsstrahlung radiation, to produce the radionuclide, wherein
a thickness of the bremsstrahlung radiation generation target is set within a range in which a production rate of the radionuclide reaches a peak, and under a condition in which an irradiation amount of the electron beam for the radionuclide production target is minimized within the range.
